(19) United States
(12) Patent Application Publication
(10) Pub. No.: US 2010/0141637 A1
(43) Pub. Date: Jun. 10, 2010

(54) METHOD FOR DRIVING PLASMA DISPLAY PANEL

(75) Inventors: Kosuke Makino, Osaka (JP); Taku Okada, Osaka (JP); Shinichiro Hashimoto, Osaka (JP); Kenji Ogawa, Osaka (JP); Shigeo Kigo, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/444,616

(22) PCT Filed: Apr. 14, 2008
(86) PCT No.: PCT/JP2008/000968

§ 371 Date: Apr. 7, 2009

(30) Foreign Application Priority Data
Apr. 25, 2007 (JP) 2007-115184

(51) Int. Cl. G09G 3/28; G09G 5/00

(52) U.S. Cl. 345/213; 345/60

(57) ABSTRACT

The plasma display panel driving method is a method of driving a panel provided with a plurality of discharge cells, each having a scan electrode and a sustain electrode, and includes forming one-field period by arranging a plurality of sub-fields including an initializing period, address period, and sustain period, wherein sustain pulse is either a first sustain pulse for generating emission having one peak at the discharge cell or a second sustain pulse for generating emission having two peaks at the discharge cell, and rise time of second sustain pulse applied to the scan electrode and rise time of second sustain pulse applied to the sustain electrode are individually set in accordance with ratios of discharge cells for emitting light in the sustain period of the sub-field.

### TECHNICAL FIELD

The present invention relates to a driving method for a plasma display panel used for a wall television or large-sized monitor.

### BACKGROUND ART

A typical AC surface discharge panel as a plasma display panel (hereinafter refers to as “panel”) is formed with many discharge cells between a front panel and a rear panel disposed opposite to each other. The front panel includes a plurality of paired display electrodes, each of which is formed of a pair of scan electrode and sustain electrode, and the electrodes are disposed in parallel to each other on a front substrate made of glass, and a dielectric layer and protective layer are formed so as to cover the paired display electrodes. The rear panel includes a plurality of parallel data electrodes formed on a rear substrate made of glass and a dielectric layer formed so as to cover them, on which a plurality of barrier ribs are disposed respectively in parallel to the data electrodes, and a phosphor layer is formed on the surface of the dielectric layer and the side of the barrier rib. And, the front panel and the rear panel are oppositely disposed and sealed so that the paired display electrodes and data electrodes are positioned in a way of two-level crossing, and for example, discharge gas containing xenon 5% in partial pressure ratio is sealed in the internal discharge space. A discharge cell is formed in a position where the display electrode and the data electrode are opposed to each other. In a panel having such a configuration, ultraviolet ray is generated by gas discharge in each discharge cell, and the phosphor of each color of red, green and blue is excited with the ultraviolet ray and emits light thereby realizing color display.

As a method of driving the panel, generally employed is a sub-field method, that is, one field period is divided into a plurality of sub-fields, and then gray scale display is obtained by changing the combinations of sub-fields for light emission. Each sub-field includes initializing period, address period, and sustain period. In the initializing period, initializing discharge is generated, and wall electric charge necessary for subsequent address operation is formed on each electrode. In the address period, address discharge is generated at the discharge cell for display to form wall electric charge. And in the sustain period, sustain pulses are alternately applied to the paired display electrodes in order to generate sustain discharge at the discharge cell so that light is emitted from the phosphor layer of the corresponding discharge cell to display images.

As a circuit for applying sustain pulses to the paired display electrodes, a so-called power recovery circuit capable of reducing the power consumption is generally employed. Aiming at the fact that a pair of display electrodes is a capacitive load, and using a resonance circuit including an inductor as its component element, the inductor and interelectrode capacitance are subjected to LC resonance, then the electric charge accumulated in the interelectrode capacitance is recovered, and the recovered electric charge is reused for driving the paired display electrodes.

On the other hand, with the recent trend of demand for a panel having a larger and finer screen, various efforts are made to enhance the emission efficiency of the panel and to improve the luminance. For example, it is now examined to greatly enhance the emission efficiency by enhancing xenon partial pressure. However, if xenon partial pressure is enhanced, it will give rise to the variation of generation timing of discharge and it will often cause non-uniform display luminance due to variation in emission intensity in every discharge cell. In order to improve such non-uniform luminance, for example, a driving method for obtaining uniform display luminance is disclosed such that a sustain pulse of acute rise is inserted by once every plurality of times to adjust the generation timing of sustain discharge. Such a method is disclosed, for example, in Patent document 1.

However, if xenon partial pressure is enhanced in order to enhance the emission efficiency, there arises another problem such that, in the case of displaying an image of high luminance after displaying a still image or the like for a long period of time, the still image is recognized as an afterimage, that is, an afterimage phenomenon is liable to take place and it will affect the quality of image display.

Patent document 1: Unexamined Japanese Patent Publication 2005-338120.

### DISCLOSURE OF THE INVENTION

The panel driving method of the present invention is intended to solve these problems, and the object is to provide a panel driving method capable of reducing the afterimage phenomenon and making uniform the display luminance of each discharge cell.

The driving method for a plasma display panel is a method of driving a plasma display panel provided with a plurality of discharge cells, each having a scan electrode and a sustain electrode, which includes forming one-field period by arranging a plurality of sub-fields having an initializing period for generating initializing discharge at discharge cells, an address period for generating address discharge at discharge cells, and a sustain period for emitting light from discharge cells by alternately applying sustain pulses to the scan electrode and sustain electrode, wherein the sustain pulse is either a first sustain pulse for generating emission having one peak from the discharge cell or a second sustain pulse for generating emission having two peaks from the discharge cell, and the rise time of the second sustain pulse applied to the scan electrode and the rise time of the second sustain pulse applied to the sustain electrode are individually set on the basis of the ratio of discharge cells emitting light during the sustain period of sub-fields.

### BRIEF DESCRIPTION OF THE DRAWINGS

FIG. 1 is an exploded perspective view showing the structure of a panel used on the preferred embodiment of the present invention.

FIG. 2 is an electrode layout of a panel used in the preferred embodiment of the present invention.

FIG. 3 is a circuit block diagram of a plasma display device in the preferred embodiment of the present invention.

FIG. 4 is chart showing waveforms of drive voltage applied to each electrode of the panel in the preferred embodiment of the present invention.

FIG. 5A is a chart showing the detail of sustain pulse used in the preferred embodiment of the present invention.

FIG. 5B is a chart showing the detail of sustain pulse used in the preferred embodiment of the present invention.

FIG. 6 shows the relationship between rise time and lighting rate with respect to second sustain pulses applied to the scan electrode and sustain electrode in the preferred embodiment of the present invention.

FIG. 7 shows an example of layout of first sustain pulse and second sustain pulse in the preferred embodiment of the present invention.

FIG. 8 is a circuit diagram of a scan electrode driving circuit and sustain electrode driving circuit in the preferred embodiment of the present invention.

Description of the Reference Numerals and Signs

| | |
|---|---|
| 10 | Panel |
| 22 | Scan electrode |
| 23 | Sustain electrode |
| 24 | Paired display electrode |
| 32 | Data electrode |
| 41 | Image signal processing circuit |
| 42 | Data electrode driving circuit |
| 43 | Scan electrode driving circuit |
| 44 | Sustain electrode driving circuit |
| 45 | Timing generation circuit |
| 50, 60 | Sustain pulse generator |
| 51, 61 | Power recovery section |
| 52, 62 | Clamp section |
| 100 | Plasma display device |
| C10, C20 | Capacitor (for power recovery) |
| Cp | Interelectrode capacitance |
| Q11, Q12, Q13, | Switching element |
| Q14, Q21, Q22, | |
| Q23, Q24 | |
| D11, D12, | Diode (for reverse current prevention) |
| D21, D22 | |
| L10, L20 | Inductor |

### DETAILED DESCRIPTION OF THE PREFERRED EMBODIMENTS

A plasma display device in the preferred embodiment of the present invention will be described in the following with reference to the drawings.

### Preferred Embodiment

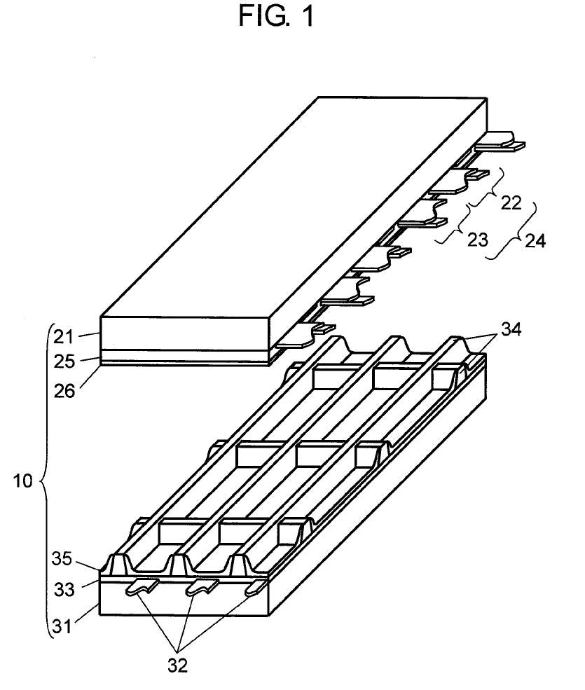

FIG. 1 is an exploded perspective view showing the structure of panel 10 used in the preferred embodiment of the present invention. A plurality of paired display electrodes 24 formed of scan electrode 22 and sustain electrode 23 are formed on front substrate 21 made of glass. And dielectric layer 25 is formed so as to cover the paired display electrodes 24, and protective layer 26 is formed on dielectric layer 25. A plurality of data electrodes 32 are formed on rear substrate 31, and dielectric layer 33 is formed so as to cover the data electrodes 32, on which crib-like barrier rib 34 is further formed. And, phosphor layer 35 for emitting each color light of red, green, and blue is disposed on the side of barrier rib 34 and dielectric layer 33.

Front substrate 21 and rear substrate 31 are disposed opposite to each other so that paired display electrodes 24 intersect data electrodes 32 with a slight discharge space therebetween, and the outer periphery thereof is tight-sealed by a sealing material such as glass frit or the like. And the discharge space is charged with a discharge gas for example containing xenon 10% in partial pressure ratio. The discharge space is divided into a plurality of sections by barrier ribs 34, and discharge cells are formed at portions where paired display electrodes 24 intersect data electrodes 32. And these discharge cells discharge electricity and emit light to display images.

The structure of panel 10 is not limited to the one mentioned above, but for example it is also preferable to comprise striped barrier ribs.

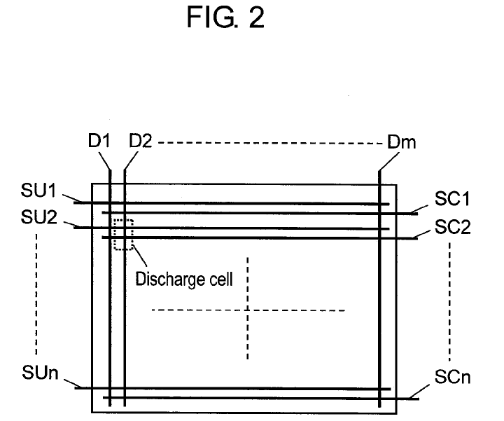

FIG. 2 is an electrode layout of panel 10 used in the preferred embodiment of the present invention. Panel 10 is provided with n pieces of scan electrodes SC1 to SCn (scan electrode 22 in FIG. 1) and n pieces of sustain electrodes SU1 to SUn (sustain electrode 23 in FIG. 1) which are long in the direction of line, and with m pieces of data electrodes D1 to Dm (data electrode 32 in FIG. 1) which are long in the direction of row. And, discharge cell is formed at a portion where a pair of scan electrode SCi (i=1˜n) and sustain electrode SUi intersects one data electrode Dj (j=1˜m), and m×n pieces of discharge cells are formed in the discharge space. As shown in FIG. 1 and FIG. 2, since scan electrode SCi and sustain electrode SUi are paired in parallel to each other, there exists interelectrode capacitance Cp between scan electrode SC1 to SCn and sustain electrode SU1 to SUn.

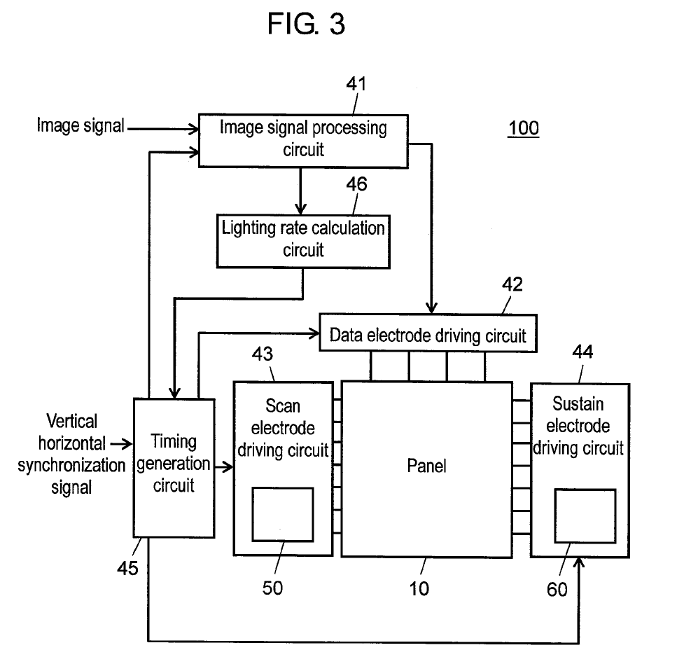

FIG. 3 is a circuit block diagram of plasma display device 100 in the preferred embodiment of the present invention. Plasma display device 100 comprises panel 10, image signal processing circuit 41, data electrode driving circuit 42, scan electrode driving circuit 43, sustain electrode driving circuit 44, timing generation circuit 45, lighting rate calculating circuit 46, and power supply circuit (not shown) for supplying power to each circuit.

Image signal processing circuit 41 converts the inputted image signal into an image data showing emission or non-emission of light for every sub-field. Data electrode driving circuit 42 converts the image data for every sub-field into a signal corresponding to each data electrode D1 to Dm in order to drive each data electrode D1 to Dm. Lighting rate calculating circuit 46 calculates the lighting rate of discharge cell for every sub-field, that is, it calculates the ratio of the number of discharge cells for generation of sustain discharge to the total number of discharge cells, in accordance with the image data for every sub-field. And, the calculated lighting rate is outputted to timing generation circuit 45.

Timing generation circuit 45 generates various kinds of timing signals for controlling the operation of each circuit on the basis of horizontal synchronization signal, vertical synchronization signal, and lighting rate outputted from lighting rate calculating circuit 46, and sends the signals to each circuit. Scan electrode driving circuit 43 has sustain pulse generator 50 for generating sustain pulses, and drives each of scan electrodes SC1 to SCn in accordance with the timing signal. Sustain electrode driving circuit 44 has sustain pulse generator 60 for generating sustain pulses, and drives sustain electrodes SU1 to SUn in accordance with the timing signal.

The drive voltage waveform for driving panel 10 and its operation will be described in the following. Plasma display device 100 executes gray scale display by a sub-field method, that is, dividing one field period into a plurality of sub-fields and controlling the emission or non-emission of light from each discharge cell for every sub-field. Each sub-field includes an initializing period, address period, and sustain period.

In the initializing period, initializing discharge is generated, and wall electric charge necessary for subsequent address discharge is formed on each electrode. In the address period, address discharge is generated at the discharge cell for emission of light to form wall electric charge. And in the sustain period, sustain pulses corresponding to the luminance weight are alternately applied to paired display electrodes 24, and sustain discharge is generated at the discharge cell generating the address discharge, thereby emitting light.

In this preferred embodiment, one field is divided into 10 sub-fields (1st SF, 2nd SF, . . . 10th SF), and each sub-field is supposed to have, for example, a luminance weight of (1, 2, 3, 6, 11, 18, 30, 44, 60, 80) respectively. However, the present invention is not limited to these values with respect to the number of sub-fields and the luminance weight of each sub-field. It is also preferable to be configured in that the sub-field configuration is switched in accordance with the image signal or the like.

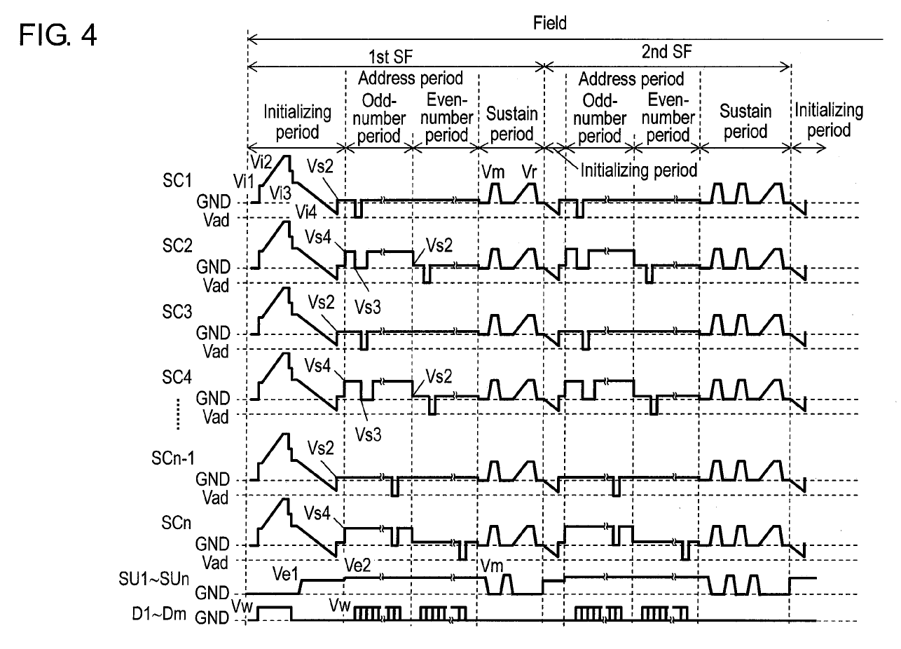

The outline of drive voltage waveform is described in the following. FIG. 4 shows the drive voltage waveform applied to each electrode of panel 10 in the preferred embodiment of the present invention, showing the drive voltage waveforms in 1st SF and 2nd SF.

In the first half of initializing period of 1st SF, address pulse voltage Vw is applied to data electrodes D1 to Dm, and voltage 0 (V) is applied to sustain electrodes SU1 to SUn. And, to scan electrodes SC1 to SCn is applied a gradient waveform voltage that gently increases from voltage Vi 1 that is lower than the discharge start voltage toward voltage Vi 2 that is higher the discharge start voltage with respect to sustain electrodes SU1 to SUn. While the gradient waveform voltage is increasing, slight initializing discharge takes place between scan electrode SC1 to SCn and sustain electrode SU1 to SUn, and data electrode D1 to Dm, respectively. And, negative wall voltage is accumulated on scan electrode SC1 to SCn, and also, positive wall voltage is accumulated on data electrode D1 to Dm and sustain electrode SU1 to SUn. Here, wall voltage on electrode represents a voltage generated due to wall electric charge accumulated on the dielectric layer covering the electrodes, protective layer, phosphor layer, etc.

In the second half of initializing period, voltage 0(V) is applied to data electrodes D1 to Dm, and positive voltage Ve 1 is applied to sustain electrodes SU1 to SUn. And, to scan electrodes SC1 to SCn is applied a gradient waveform voltage that gently decreases from voltage Vi 3 that is lower than the discharge start voltage toward voltage Vi 4 that is higher the discharge start voltage with respect to sustain electrodes SU1 to SUn. During the time, slight initializing discharge takes place between scan electrode SC1 to SCn and sustain electrode SU1 to SUn, and data electrode D1 to Dm, respectively. And, the negative wall voltage on scan electrode SC1 to SCn and the positive wall voltage on sustain electrode SU1 to SUn are lowered, and thereby, the positive wall voltage on data electrode D1 to Dm is adjusted to a value suited for address operation.

Out of the sub-fields forming one field, the first half of initializing period can be omitted in some sub-fields, and in that case, the initializing operation is selectively executed with respect to discharge cells performing sustain discharge just in the preceding sub-field. FIG. 4 shows drive voltage waveforms for executing the initializing operation including the first half and second half in the initializing period of 1st SF and for executing the initializing operation including only the second half in the initializing period of 2nd SF and thereafter.

In the subsequent address period, in the present preferred embodiment, scan electrodes SC1 to SCn are divided into an odd-number scan electrode group and an even-number scan electrode group. The address operation is performed by dividing the address period into an odd-number address period (hereinafter called “odd-number period”) for sequentially applying scan pulses to each of scan electrodes SC1, SC3, . . . SCn−1 belonging to the odd-number scan electrode group and an even-number address period (hereinafter called “even-number period”) for sequentially applying scan pulses to each of scan electrodes SC2, SC4, . . . SCn belong to the even-number scan electrode group.

In the odd-number period, voltage Ve 2 is applied to sustain electrode SU1 to SUn, second voltage Vs 2 is applied to each of odd-number scan electrodes SC1, SC3, . . . SCn−1, and fourth voltage Vs 4 is applied to each of even-number scan electrodes SC2, SC4, . . . SCn. Here, fourth voltage Vs 4 is a voltage higher than second voltage Vs 2.

Subsequently, for applying a negative scan pulse to first scan electrode SC1, scan pulse voltage Vad that is the first voltage is applied thereto. And, positive address pulse voltage Vw is applied to data electrode Dk (k=1˜m) of the discharge cell for emitting light in the first line out of data electrodes D1 to Dm. Then, in this preferred embodiment, third voltage Vs 3 that is lower than fourth voltage Vs 4 is applied to the scan electrode adjoining the scan electrode SC1 that is second scan electrode SC2. The purpose of this is to prevent excessive difference in voltage from being applied between adjoining scan electrode SC1 and scan electrode SC2.

In this way, the difference in voltage at the intersection between data electrode Dk of the discharge cell to which address pulse voltage Vw is applied and scan electrode SC1 becomes same as the one obtained by adding the difference in wall voltage between data electrode Dk and scan electrode SC1 to the externally applied voltage difference (Vw−Vad), exceeding the discharge start voltage. And, address discharge takes place between data electrode Dk and scan electrode SC1 and between sustain electrode SU1 and scan electrode SC1, then positive wall voltage is accumulated on scan electrode SC1, negative wall voltage is accumulated on sustain electrode SU1, and negative wall voltage is accumulated on data electrode Dk as well.

Thus, a scan pulse transferring from second voltage Vs2 higher than scan pulse voltage Vad to scan pulse voltage Vad and again to second voltage Vs2 is applied to scan electrode SC1 belonging to the odd-number scan electrode group. Either one of third voltage Vs3 higher than scan pulse voltage Vad and fourth voltage Vs4 higher than second voltage Vs2 and third voltage Vs3 is applied to scan electrodes SC2, SC4, SCn belonging to the even-number scan electrode group. Third voltage Vs3 is applied to scan electrode SC2 while scan pulse voltage Vad is applied to adjoining scan electrode SC1. In this way, address discharge takes place at the discharge cell for emitting light in the first line, thereby executing the address operation for accumulating wall voltage on each electrode. On the other hand, the voltage at the intersection between data electrode D1 to Dm to which address pulse voltage Vw is not applied and scan electrode SC1 is not higher than the discharge start voltage, and therefore, there is no generation of address discharge.

Next, scan pulse voltage Vad is applied to third scan electrode SC3, and also, positive address pulse voltage Vw is applied to data electrode Dk of the discharge cell for emitting light at the third line out of data electrodes D1 to Dm. In this case, third voltage Vs3 is also applied to second scan electrode SC2 and fourth scan electrode SC4 which are adjoining the scan electrode SC3. Then, address discharge takes place between data electrode Dk and scan electrode SC3 and between sustain electrode SU3 and scan electrode SC3 of the discharge cell, thereby executing the address operation for accumulating wall voltage on each electrode.

The address operation is similarly executed with respect to the odd-number scan electrodes SC5, SC7, . . . SCn−1 as well. And third voltage Vs3 is also applied the even-number scan electrode SCp and scan electrode SCp+2 adjoining the odd-number scan electrode SCp+1 (p=even number, 1<p<n) then executing the address operation.

In the subsequent even-number period, while second voltage Vs2 is being applied to the odd-number scan electrodes SC1, SC3, . . . SCn−1, second voltage Vs2 is applied to the even-number scan electrodes SC2, SC4, . . . SCn as well.

Subsequently, for applying a negative scan pulse to second scan electrode SC2, scan pulse voltage Vad is applied thereto, and positive address pulse voltage Vw is applied to data electrode Dk of the discharge cell for emitting light in the second line out of data electrodes D1 to Dm. Then, the difference in voltage at the intersection between data electrode Dk and scan electrode SC2 of the discharge cell becomes higher than the discharge start voltage, and address discharge takes place at the discharge cell for emitting light in the second line, thereby executing the address operation for accumulating wall voltage in each electrode.

Next, scan pulse voltage Vad is applied to fourth scan electrode SC4, and also, positive address pulse voltage Vw is applied to data electrode Dk of the discharge cell for emitting light in the fourth line. Then, address discharge takes place at the discharge cell.

Similarly, scan pulse voltage Vad is applied to the even-number scan electrodes SC6, SC8, . . . SCn, thereby executing the address operation.

Also in the even-number period, it is preferable that fourth voltage Vs4 is applied to each of odd-number scan electrodes SC1, SC3, . . . SCn−1 and that third voltage Vs3 is applied to odd-number scan electrode SCp−1 and scan electrode SCp+1 adjoining the even-number scan electrode SCp for executing the address operation.

However, even in case of driving as in the present preferred embodiment, there is no fear of damage to insulation or generation of migration because of no excessive difference in voltage applied between the adjoining scan electrodes. Also, since the address operation of the odd-number scan electrode is already completed in the odd-number period, there is no fear of damage to the image display quality even in case of decrease in wall electric charge of the odd-number scan electrode in the even-number period.

In the subsequent sustain period, positive sustain pulse voltage Vm is first applied to scan electrodes SC1 to SCn, and also, voltage 0 (V) is applied to sustain electrodes SU1 to SUn. Then, at the discharge cell where address discharge takes place, the difference in voltage between scan electrode SCi and sustain electrode SUi becomes equal to the one with the difference between the wall voltage of scan electrode SCi and the wall voltage of sustain electrode SUi added to sustain pulse voltage Vm, exceeding the discharge start voltage. And, sustain discharge takes place between scan electrode SCi and sustain electrode SUi, and phosphor layer 35 emits light due to ultraviolet ray then generated. And negative wall voltage is accumulated on scan electrode SCi, and positive wall voltage is accumulated on sustain electrode SUi. Further, positive wall voltage is accumulated on data electrode Dk as well. At the discharge cell where no address discharge takes place in the address period, there is no generation of sustain discharge, and the wall voltage at the end of the initializing period will be maintained.

Subsequently, voltage 0 (V) is applied to scan electrodes SC1 to SCn, and sustain pulse voltage Vm is applied to sustain electrodes SU1 to SUn. Then, at the discharge cell where sustain discharge takes place, the difference in voltage between sustain electrode SUi and scan electrode SCi exceeds the discharge start voltage, and therefore, sustain discharge again takes place between sustain electrode SUi and scan electrode SCi, and as a result, negative wall voltage is accumulated on sustain electrode SUi and positive wall voltage is accumulated on scan electrode SCi. Similarly thereafter, sustain pulses according to the luminance weight are alternately applied to scan electrodes SC1 to SCn and sustain electrodes SU1 to SUn, giving potential difference between the electrodes of paired display electrodes 24, and thereby, sustain discharge is continuously performed at the discharge cell where address discharge takes place in the address period.

And, at the final stage of sustain period, gradient waveform voltage gently increasing toward voltage Vr is applied to scan electrodes SC1 to SCn, and with positive wall voltage kept remaining on data electrode Dk, the wall voltages on scan electrode SCi and sustain electrode SUi are eliminated. In the present preferred embodiment, voltage Vr is equal to or higher than sustain pulse voltage Vm. Thus, the sustain operation in the sustain period is completed.

In the present preferred embodiment, the lighting rate for every sub-field calculated by lighting rate calculating circuit 46, the rises of sustain pulses waveforms applied to scan electrode SC1 to SCn and sustain electrode SU1 to SUn are individually controlled. In this way, the afterimage phenomenon is reduced, and uniform display luminance of each discharge cell is obtained. The detail of sustain pulse waveform will be described in the following.

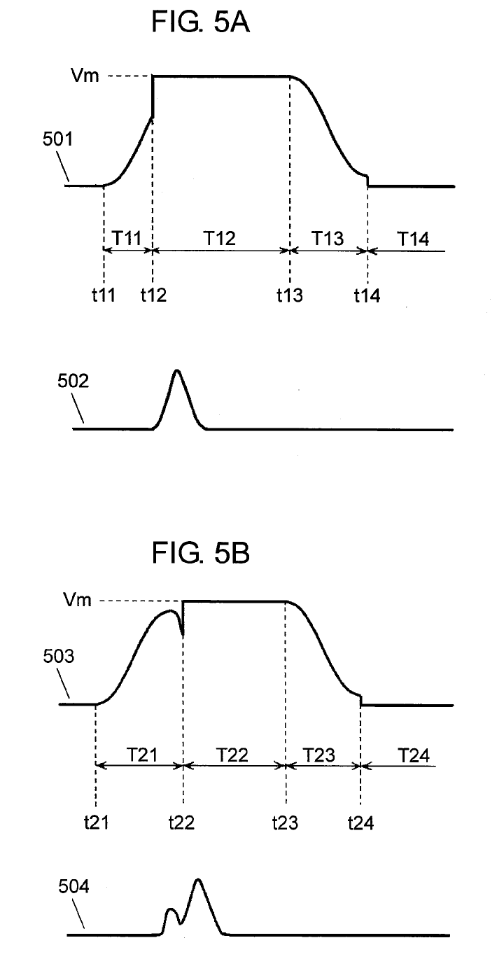

FIG. 5A and FIG. 5B show the detail of two sustain pulses used in the preferred embodiment of the present invention. In the present preferred embodiment, sustain discharge is generated by using first sustain pulse 501 for generating emission 502 having one peak (hereinafter called “one-peak emission 502”) and second sustain pulse 503 for generating emission 504 having two peaks (hereinafter called “two-peak emission 504”). FIG. 5A is a schematic diagram showing the waveform of first sustain pulse 501 and a state of emission 502 at the time. Rise time T11 is 350 ns with respect to both of first sustain pulse 501 applied to scan electrodes SC1 to SCn and first sustain pulse 501 applied to sustain electrodes SU1 to SUn. And the value is constant irrespective of the lighting rate of sub-field. FIG. 5B is a schematic diagram showing the waveform of second sustain pulse 503 and a state of emission 504 at the time, and rise time T21 of second sustain pulse 503 is set within a range from 450 ns to 550 ns. And in the present preferred embodiment, the rise time is individually set in accordance with the lighting rate of sub-field with respect to each of second sustain pulse 503 applied to scan electrodes SC1 to SCn and second sustain pulse 503 applied to sustain electrodes SU1 to SUn. Incidentally, period T11 in FIG. 5A is the rise time of first sustain pulse 501, that is the period from time t11 to time t12. Period T21 in FIG. 5B is the rise time of second sustain pulse 503, that is the period from time t21 to time t22.

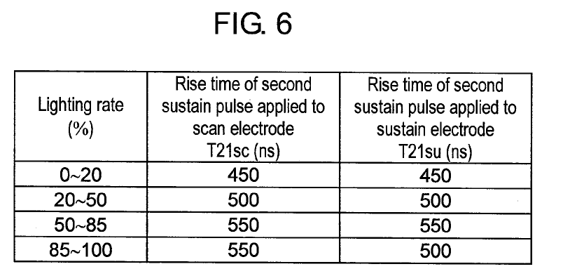

FIG. 6 shows the relations of rise time T21sc of second sustain pulse 503 applied to scan electrodes SC1 to SCn and rise time T21su of second sustain pulse 503 applied to sustain electrodes SU1 to SUn, and lighting rates. The rise time is 450 ns with respect to both of rise time T21sc of second sustain pulse 503 applied to scan electrodes SC1 to SCn and rise time T21su of second sustain pulse 503 applied to sustain electrodes SU1 to SUn in the sustain period of sub-field whose lighting rate is less than 20%. Also, the rise time is 500 ns with respect to both of rise time T21sc of second sustain pulse 503 applied to scan electrodes SC1 to SCn and rise time T21su of second sustain pulse 503 applied to sustain electrodes SU1 to SUn in the sustain period of sub-field whose lighting rate is 20% or over and less than 50%. Also, the rise time is 550 ns with respect to both of rise time T21sc of second sustain pulse 503 applied to scan electrodes SC1 to SCn and rise time T21su of second sustain pulse 503 applied to sustain electrodes SU1 to SUn in the sustain period of sub-field whose lighting rate is 50% or over and less than 85%. And, in a sub-field whose lighting rate is 85% or over, rise time T21sc of second sustain pulse 503 applied to scan electrodes SC1 to SCn is 550 ns, and rise time T21su of second sustain pulse 503 applied to sustain electrodes SU1 to SUn is 500 ns.

Thus, when the lighting rate is 85% or over, rise time T21sc of second sustain pulse 503 applied to scan electrodes SC1 to SCn is set longer than rise time T21su of second sustain pulse 503 applied to sustain electrodes SU1 to SUn. And in the sustain period of each sub-field, sustain discharge is generated by applying first sustain pulse 501 and second sustain pulse 503 to scan electrodes SC1 to SCn and sustain electrodes SU1 to SUn.

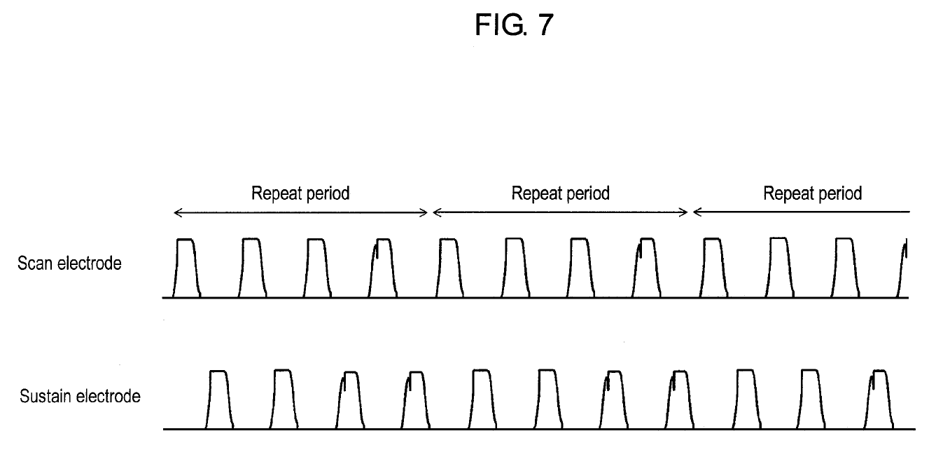

FIG. 7 shows an example of layout of first sustain pulse 501 and second sustain pulse 503 in the preferred embodiment of the present invention. In this example of layout, first sustain pulse 501 for generating one-peak emission 502 is applied to scan electrode SC1 to SCn and sustain electrode SU1 to SUn alternately repeatedly five times, and after that, second sustain pulse 503 for generating two-peak emission 504 is applied to scan electrode SC1 to SCn and sustain electrode SU1 to SUn alternately three times. That is, first sustain pulse 501 is applied to paired display electrode 24 alternately repeatedly five times, and second sustain pulse 503 is applied to paired display electrode 24 alternately three times. Similarly thereafter, first sustain pulse 501 is applied to paired display electrode 24 alternately repeatedly five times, and second sustain pulse 503 is applied to paired display electrode 24 alternately three times. In this way, a cycle of applying first sustain pulse 501 five times and second sustain pulse 503 three times is repeated to apply sustain pulses to paired display electrodes 24 in accordance with the luminance weight. However, the present invention is not limited to this layout, and as for the ratio and order of first sustain pulse 501 and second sustain pulse 503 applied to scan electrodes SC1 to SCn, it is desirable to make the best setting in order to suppress the afterimage phenomenon. Also, it is desirable to make optimal setting for suppressing the afterimage phenomenon with respect to the ratio and order of first sustain pulse 501 and second sustain pulse 503 applied to sustain electrodes SU1 to SUn.

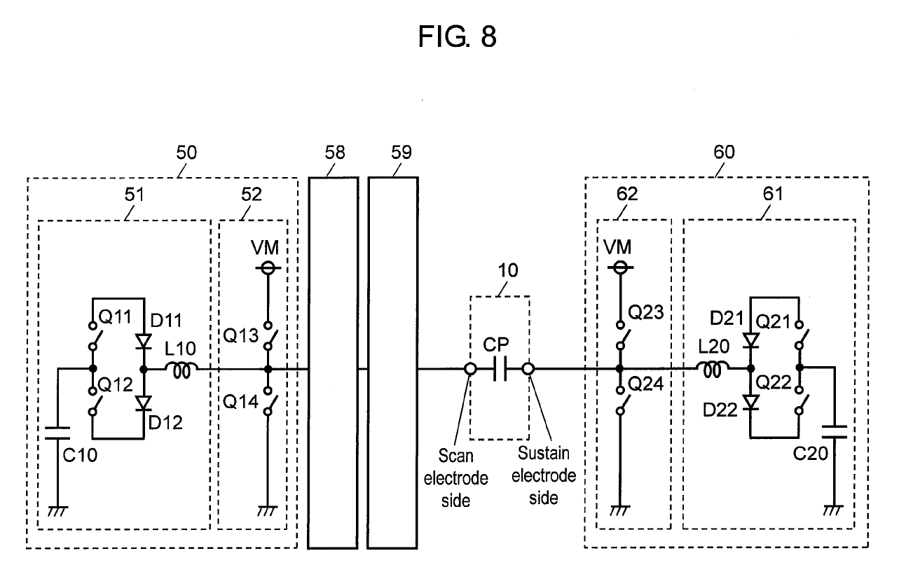

The detail and operation of sustain pulse generator 50, 60 for generating sustain pulses will be described in the following. FIG. 8 is a circuit diagram of scan electrode driving circuit 43 and sustain electrode driving circuit 44 in the preferred embodiment of the present invention. In FIG. 8, the interelectrode capacitance of panel 10 is represented by Cp.

Scan electrode driving circuit 43 comprises sustain pulse generator 50, initializing waveform generator 58, and scan pulse generator 59. Sustain electrode driving circuit 44 comprises sustain pulse generator 60.

Sustain pule generator 50 comprises power recovery section 51 and clamp section 52. Power recovery section 51 includes capacitor C10 for power recovery, switching element Q11, Q12, diode D11, D12 for reverse current prevention, and inductor L10 for resonance.

Power recovery section 51 makes LC resonance of interelectrode capacitance Cp and inductor L10 for executing the rise and fall of sustain pulse. At the rise of sustain pulse, the electric charge accumulated in capacitor C 10 for power recovery is transferred to interelectrode capacitance Cp via switching element Q11, diode D11, and inductor L10. At the fall of sustain pulse, the electric charge accumulated in interelectrode capacitance Cp is returned to capacitor C10 for power recovery via inductor L10, diode D12, and switching element Q12. In this way, sustain pulse is applied to scan electrodes SC1 to SCn. Thus, power recovery section 51 drives scan electrodes SC1 to SCn through LC resonance, resulting in reduction of power consumption. Capacitor C10 for power recovery has a capacity larger enough as compared with interelectrode capacitance Cp and is charged with about Vm/2 that is a half of voltage value Vm of power source VM so that it serves as a power source for power recovery section 51.

Clamp section 52 comprises switching element Q13 and switching element Q14.

Clamp section 52 connects scan electrodes SC1 to SCn to power source VM via switching element Q13, and clamps scan electrodes SC1 to SCn at sustain pulse voltage Vm. Also, clamp section 52 grounds scan electrode SC1 to SCn via switching element Q14, and clamps them at voltage 0 (V). In this way, clamp section 52 serves to drive scan electrodes SC1 to SCn. Accordingly, the impedance at the time of voltage application by clamp section 52 is low, and therefore a high-level discharge current induced by intensive sustain discharge can flow reliably.

Thus, sustain pulse generator 50 controls switching elements Q11, Q12, Q13, Q14 in order to apply sustain pulses to scan electrodes SC1 to SCn by using power recovery section 51 and clamp section 52. These switching elements Q11, Q12, Q13, Q14 can be designed by using commonly known elements such as MOSFET and IGBT.

And power recovery section 51 and clamp section 52 are connected to scan electrodes SC1 to SCn at one end of interelectrode capacitance Cp of panel 10 via initializing waveform generator 58 and scan pulse generator 59.

Sustain pulse generator 60 of sustain electrode driving circuit 44 comprises power recovery section 61 and clamp section 62, and is connected to sustain electrodes SU1 to SUn at one end of interelectrode capacitance Cp of panel 10. Power recovery section 61 comprises capacitor C20 for power recovery, switching elements Q21, Q22, diodes D21, D22 for reverse current prevention, and inductor L20 for resonance. Clamp section 62 includes switching element Q23 for clamping sustain electrodes SU1 to SUn at sustain pulse voltage Vm and switching element Q24 for clamping sustain electrodes SU1 to SUn at ground potential. The operation of sustain pulse generator 60 is same as that of generator 50, and the description is omitted.

In the present preferred embodiment, with respect to the period of LC resonance between inductor L10 of power recovery section 51 and interelectrode capacitance Cp of panel 10, and the period of LC resonance (hereinafter called “resonance period”) between inductor L20 of power recovery section 61 and interelectrode capacitance Cp, both are set at about 1200 ns.

The operation of sustain pulse generator 50, 60 will be described in the following with reference to FIG. 5A and FIG. 5B. Sustain pulse generator 50 at the scan electrode SC1 to SCn side is described here, but sustain pulse generator 60 at the sustain electrode SC1 to SCn side is also same in circuit configuration and nearly same in operation. First sustain pulse 501 shown in FIG. 5A is described first. In the following description, switching elements Q11 to Q14, Q21 to Q24 are “ON” when they are conducting, and “OFF” when non-conducting.

### (Period T11)

Switching element Q11 is turned ON at time t11, then electric charge starts to move from capacitor C10 for power recovery to scan electrodes SC1 to SCn through switching element Q11, diode D11, and inductor L10, and the voltage of scan electrode SC1 to SCn starts increasing.

### (Period T12)

In first sustain pulse 501, switching element Q13 is turned ON at time t12 before the lapse of time, ½ of the resonance period, from time t11. Then, scan electrodes SC1 to SCn are connected to power source VM through switching element Q13, and scan electrodes SC1 to SCn are clamped at sustain pulse voltage Vm. When scan electrodes SC1 to SCn are clamped at sustain pulse voltage Vm, the difference in voltage between scan electrode SC1 to SCn and sustain electrode SU1 to SUn at the discharge cell where address discharge takes place exceeds the discharge start voltage causing sustain discharge to be generated. Switching element Q11 is shifted back to OFF after time t12, before time t13. Also, switching element Q13 is shifted back to OFF just before time t13.

As described above, in the present preferred embodiment, ½ of resonance period between inductor L10 and interelectrode capacitance Cp is set at about 600 ns. Also, the rise time of sustain pulses applied to scan electrode SC1 to SCn, that is, the time of period T11 ranging from time t11 to time t12 is set at about 350 ns.

### (Period T13)

Switching element Q12 is turned ON at time t13. Then, electric charge starts to move from scan electrodes SC1 to SCn to capacitor C10 through inductor L10, diode D12, and switching element Q12, and the voltage of scan electrode SC1 to SCn starts decreasing. Since a resonance circuit is formed by inductor L10 and interelectrode capacitance Cp, when time of about ½ of resonance period has passed from time t13, the voltage of scan electrode SC1 to SCn decreases to a voltage of about 0 (V).

### (Period 14)

And, switching element Q14 is turned ON at time t14. Then, scan electrodes SC1 to SCn are grounded via switching element Q14, and scan electrodes SC1 to SCn are clamped at voltage 0 (V). Switching element Q12 is shifted back to OFF after time t14, before time t11 of the next period. Also, switching element Q14 is shifted back to OFF just before time t11 of the next period.

Second sustain pulse 503 shown in FIG. 5B will be described in the following.

### (Period T21)

Switching element Q11 is turned ON at time t21. Then, electric charge starts to move from capacitor C10 for power recovery to scan electrodes SC1 to SCn through switching element Q11, diode D11, and inductor L10, and the voltage of scan electrode SC1 to SCn starts increasing. Since a resonance circuit is formed by inductor L10 and interelectrode capacitance Cp, when the specified time has passed from time t21, the voltage of scan electrode SC1 to SCn increases nearly up to sustain pulse voltage Vm. And the difference in voltage between scan electrode SC1 to SCn and sustain electrode SU1 to SUn at the discharge cell where address discharge takes place exceeds the discharge start voltage causing the first sustain discharge to be started. And due to the discharge, the voltage of scan electrode SC1 to SCn rapidly starts decreasing.

### (Period T22)

In second sustain pulse 503, switching element Q13 is turned ON at time t22 after the lapse of time of 450 ns to 550 ns from time t21 in accordance with the lighting rate. Then, scan electrodes SC1 to SCn are connected to power source VM through switching element Q13, and scan electrodes SC1 to SCn are clamped at sustain pulse voltage Vm. When scan electrodes SC1 to SCn are clamped at sustain pulse voltage Vm, the second sustain discharge takes place at the discharge cell where the first sustain discharge is started. Switching element Q11 is shifted back to OFF after time t22, before time t23. Also, switching element Q13 is shifted back to OFF just before time t23.

The operations in (period T23) and (period T24) are same as the operations in period T13 and period T14 of first sustain pulse 501 shown in FIG. 5A.

As described above, the rise time is 350 μs with respect to both of first sustain pulse 501 applied to scan electrodes SC1 to SCn and first sustain pulse 501 applied to sustain electrodes SU1 to SUn, which is set to nearly a half of about 600 ns, ½ of the resonance period between inductor L10 and interelectrode capacitance Cp. And, first sustain pulse 501 causes one sustain discharge to be generated, and then one-peak emission 502 is observed.

On the other hand, the rise time of second sustain pulse 503 is set within a range from 450 μs to 550 μs on the basis of the lighting rate of sub-field. Also, as shown in FIG. 6, the rise time of second sustain pulse 503 applied to scan electrode SC1 to SCn and the rise time of second sustain pulse 503 applied to sustain electrode SU1 to SUn are individually set. And the rise time is a little shorter than about 600 ns, ½ of the resonance period between inductor L10 and interelectrode capacitance Cp, and the second sustain pulse 503 causes two times of discharges to be generated, and then two-peak emission 504 is observed.

And, sustain discharge is generated by combining first sustain pulse 501 and second sustain pulse 503, and thereby, the occurrence of afterimage phenomenon can be reduced, and it is possible to make uniform the display luminance of each discharge cell.

The afterimage phenomenon is a phenomenon caused due to change in emission intensity of the discharge cell, depending upon the emission history of the discharge cell. For example, a still image is displayed for a long time, and when the whole screen is lighted after discharge cells emitting light and discharge cells not emitting light keep their states for a certain length of time, then an afterimage is observed. In case the emission intensity of discharge cells emitting light is higher than the emission intensity of discharge cells not emitting light, the afterimage generated is positive, and in the reverse case, the afterimage is negative. Also, when a still image is displayed for longer time, such an afterimage tends to become intensified.

The mechanism of generation of an afterimage mentioned above is not yet clarified, but the inventor et al have experimentally confirmed that it is possible to realize the reduction of afterimage phenomenon and the uniform display luminance of each discharge cell by optimizing the balance between one-peak emission 502 and two-peak emission 504 in the sustain discharge. And it has been found that for achieving the purpose of keeping the balance constant between one-peak emission 502 and two-peak emission 504, it is important to individually control the rise time T21sc of second sustain pulse 503 applied to scan electrodes SC1 to SCn and the rise time T21su of second sustain pulse 503 applied to sustain electrodes SU1 to SUn in accordance with the lighting rate.

Scan electrode SC1 to SCn is the load of sustain pulse generator 50, and sustain electrode SU1 to SUn is the load of sustain pulse generator 60, and the level of the load greatly varies depending upon the lighting rate. And as the load varies, the sustain pulse waveform applied to the discharge cell also varies, causing the sustain discharge for two-peak emission to change in discharge mode, and there is a fear of causing hindrance to the balance between one-peak emission 502 and two-peak emission 504 in sustain discharge. Accordingly, in the present preferred embodiment, the rise of second sustain pulse 503 is controlled according to the lighting rate so that the balance of one-peak emission 502 and two-peak emission 504 becomes constant even in case of variation of the sustain pulse waveform.

Also, as shown in FIG. 8, sustain pulses generated in sustain pulse generator 50 of scan electrode driving circuit 43 are supplied to scan electrodes SC1 to SCn via initializing waveform generator 58 and scan pulse generator 59. However, sustain pulses generated in sustain pulse generator 60 of sustain electrode driving circuit 44 are directly supplied to sustain electrodes SU1 to SUn. Therefore, the output impedance of sustain pulse generator 50 is greatly different from the output impedance of sustain pulse generator 60. Accordingly, when the lighting rate becomes higher, causing the load to increase, it gives rise to increase in difference between the waveform of second sustain pulse 503 applied to scan electrodes SC1 to SCn and the waveform of second sustain pulse 503 applied to sustain electrodes SU1 to SUn. In the present preferred embodiment, the rise time T21sc of sustain pulse 503 applied to scan electrodes SC1 to SCn and the rise time T21su of second sustain pulse 503 applied to sustain electrodes SU1 to SUn are individually controlled so that the balance is kept constant between one-peak emission 502 and two-peak emission 504 of sustain discharge of which scan electrodes SC1 to SCn become positive electrodes and that the balance is kept constant between one-peak emission 502 and two-peak emission 504 of sustain discharge of which sustain electrodes SU1 to SUn become positive electrodes.

Driving in this way, it is possible to make the balance constant between one-peak emission 502 and two-peak emission 504 in the sustain period and also to realize the reduction of afterimage phenomenon and the uniform display luminance of each discharge cell.

Each numeral actually used in the present preferred embodiment is only an example, and it is desirable to properly set an optimal value in accordance with the panel characteristic or the specification of the plasma display device.

According to the present invention, it is possible to provide a panel driving method capable of reducing the occurrence of afterimage phenomenon itself and realizing uniform display luminance of each discharge cell.

### INDUSTRIAL APPLICABILITY

The present invention is able to reduce the occurrence of afterimage phenomenon itself and to realize uniform display luminance of each discharge cell, which is therefore useful as a panel driving method.

1. A method of driving a plasma display panel provided with a plurality of discharge cells, each having a scan electrode and a sustain electrode, comprising:
forming one-field period by arranging a plurality of sub-fields including an initializing period for generating initializing discharge at the discharge cell, a address period for generating address discharge at the discharge cell, and a sustain period for emitting light from the discharge cell by alternately applying sustain pulses to the scan electrode and the sustain electrode,
wherein the sustain pulse is either a first sustain pulse for generating emission having one peak at the discharge cell or a second sustain pulse for generating emission having two peaks at the discharge cell, and
rise time of second sustain pulse applied to the scan electrode and rise time of second sustain pulse applied to the sustain electrode are individually set in accordance with a ratio of discharge cells for emitting light in the sustain period of sub-fields.

2. The method of driving a plasma display panel of claim 1, wherein when the ratio is larger than a predetermined threshold value, the rise time of second sustain pulse applied to the scan electrode is set longer than the rise time of second sustain pulse applied to the sustain electrode.
